(19) United States
(12) Patent Application Publication
(10) Pub. No.: US 2004/0015864 A1
(43) Pub. Date: Jan. 22, 2004

(54) Method and system for testing memory operations of computer program

(76) Inventor: Michael L. Boucher, Lafayette, CO (US)

Correspondence Address: David B. Ritchie, Thelen Reid & Priest LLP, P.O. Box 640640, San Jose, CA, 95164, US

(21) Appl. No.: 09/875,669

(22) Filed: Jun. 5, 2001

(51) Int. Cl. G06F 9/44

(52) U.S. Cl. 717/124; 717/127

(57) ABSTRACT

A method and system for testing memory operations of a computer program uses a virtual memory associated with a physical memory, the virtual memory being divided into a plurality of memory regions each having virtual addresses. The method and system comprise allocating a memory block to be used by the computer program so that a memory block boundary aligns with a boundary between a first memory region and a second memory region of the virtual memory, the memory block being entirely within the first memory region, executing the computer program using the virtual memory, and detecting any instances of the computer program accessing the second region of the virtual memory. The first memory region is a mapped region having virtual addresses associated with real addresses, and the second memory region is an unmapped region having virtual addresses not associated with real addresses.

### FIELD OF THE INVENTION

The present invention relates to the field of developing computer programs. More particularly, the present invention relates to a method and system for testing memory operations of a computer program.

### BACKGROUND OF THE INVENTION

A specification of the behavior of a computer program or subprogram may specify areas of memory that the specified program or subprogram is allowed to access and what operations it can perform on the specified memory area. Such operations include reading, writing, and executing the contents of the memory. In developing computer software, a complete set of tests of a computer program or subprogram should include tests that make sure that the program or subprogram does not access memory outside of the specified range. Such memory access violation includes memory overrun (over-indexing) and underrun (under-indexing).

Memory overrun occurs when a program performs memory operations exceeding the upper boundary of an allocated memory area. For example, as shown in FIG. 1A, when a computer program to which 10 address locations (or memory area of size 10) are allocated uses 11 or more address locations, the computer program “overruns” or “over-indexes” the memory area. Memory underrun is a similar memory access violation in the opposite direction, as shown in FIG. 1B.

There are many ways to test a program (or subprogram) that involve changing either the source code or the generated code. For example, Sun Performance Workshop™ Fortran, available from Sun Microsystems, Inc., Palo Alto, Calif., has a compiler switch or command modifier (-C) that generates code to check for memory array overruns. Such a memory overrun is detected by checking inconsistencies in definition and use of memory area in the source code.

However, in general, the generated code cannot check a memory area the bounds of which are not known to the program or subprogram to be tested. For example, a memory overrun/underrun may not be checked when a computer program or subprogram calls a subroutine that uses an unspecified number of memory arrays, or when a computer program accesses non-array memory blocks such as data blocks whose start is indicated by pointers and thus lacks indication of the end of the array.

In some conventional runtime tests for memory operations, the source code of a computer program is typically modified to call a memory check routine for each memory access instruction so as to monitor each memory operation during the execution of the program. Such a modified program is referred to as an “instrumented” program, and it is difficult to monitor memory operations without modifying the source code. However, having to test such an instrumented program has a drawback since the modified code requires a cumbersome recompilation of the program the size of which is also larger than that of the original program. Furthermore, testing modified code may conceivably fail to detect errors that arise in the original (unmodified) source code and is thus not entirely reliable.

In addition, in order to instrument a program, or alternatively to check an inconsistent memory use against memory definition, the original source code of a computer program must be available. However, it is often necessary for a software developer to test a program that exists only in object code without having access to the original source code of the computer program.

Accordingly, it would be desirable to test memory operations of a computer program without modifying the source code, and to check memory operations of a computer program by directly executing the compiled computer program.

### BRIEF DESCRIPTION OF THE INVENTION

A method and system for testing memory operations of a computer program uses a virtual memory associated with a physical memory, the virtual memory being divided into a plurality of memory regions each having virtual addresses. The method and system comprise allocating a memory block to be used by the computer program so that a memory block boundary aligns with a boundary between a first memory region and a second memory region of the virtual memory, the memory block being entirely within the first memory region, executing the computer program using the virtual memory, and detecting any instances of the computer program accessing the second region of the virtual memory. The first memory region is a mapped region having virtual addresses associated with real addresses, and the second memory region is an unmapped region having virtual addresses not associated with real addresses. The detection of an invalid memory access may include observing an access fault caused by the computer program accessing the unmapped region. The allocation of the memory block may include determining a size of the memory block and determining a starting address in the first memory region so that the memory block ends at the end of the first region.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1A is a diagram schematically illustrating a memory overrun (over-indexing) of a computer program.

FIG. 1B is a diagram schematically illustrating a memory underrun (under-indexing) of a computer program.

FIG. 2 is a block diagram schematically illustrating a system for testing memory operations of a computer program in accordance with a specific embodiment of the present invention.

FIG. 3 is a diagram schematically illustrating allocation of a memory block in a virtual memory in accordance with a specific embodiment of the present invention.

FIG. 4 is a diagram schematically illustrating allocation of a memory block and unmapped region in a virtual address space for testing a memory overrun in accordance with a specific embodiment of the present invention.

FIG. 5 is a diagram schematically illustrating allocation of a memory block and unmapped region in a virtual address space for testing a memory underrun in accordance with a specific embodiment of the present invention.

FIG. 6 is a diagram schematically illustrating allocation of a memory block and unmapped region in a virtual address space in which virtual pages are arranged in a matrix form.

FIG. 7 is a process flow diagram schematically illustrating a method for testing memory operations of a computer program in accordance with a specific embodiment of the present invention.

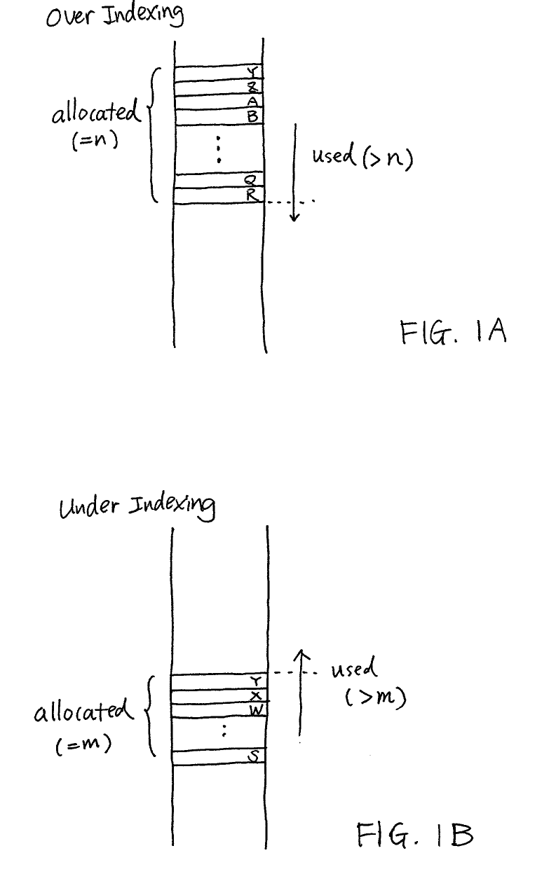

### DETAILED DESCRIPTION

Embodiments of the present invention are described herein in the context of a method and system for testing memory operations of a computer program. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines.

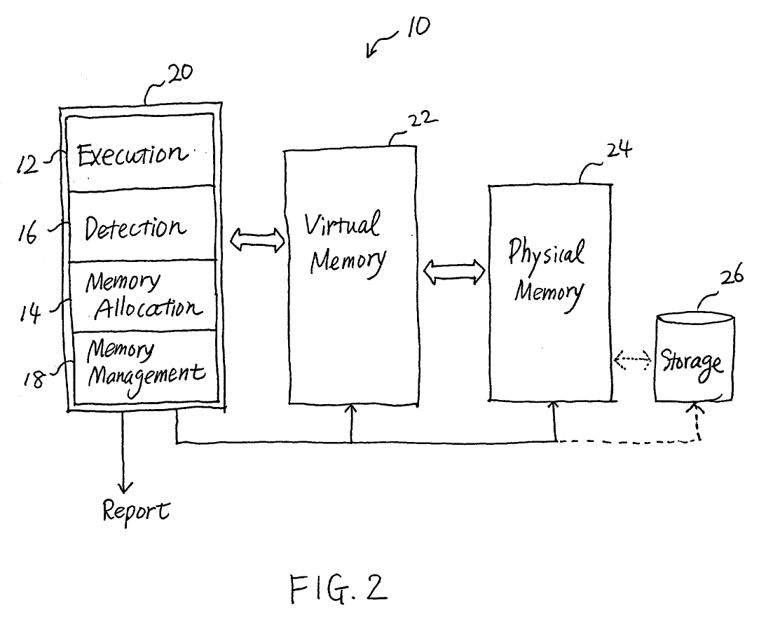

FIG. 2 schematically illustrates a system 10 for testing memory operations of a computer program according to one embodiment of the present invention. The system 10 includes an execution module 12, a memory allocation module (memory allocator) 14, an error detection module (error detector) 16, and a memory management module (memory manager) 18. These modules may be implemented in a CPU 20. The system 10 also includes a physical memory 24, such as a RAM, and a virtual memory 22 associated with the physical memory 24. The system 10 may also include a conventional storage device 26, such as a disk drive, from which data or information is loaded onto the physical memory 24 in executing a computer program for testing.

The execution module 12 executes a specified computer program to be tested. Such a computer program may be an application, a subprogram, a program module, an executable, and the like, and may include one or more subroutines. The memory manager 18, the virtual memory 22, and the physical memory 24 may be included in a memory management system which provides processes of a computer program with access to a defined range of the physical memory 24.

The physical memory 24 has a physical (i.e., real) address space having real memory addresses. The physical address space is typically divided into a plurality of regions, such as pages with (in one specific embodiment) a typical size of 8 kilobytes (KB), though the size of a page is programmable. The virtual memory 22 has a virtual address space having a plurality of virtual memory addresses. A virtual memory space is also typically divided into a plurality of regions, such as pages in the same manner as a physical memory space. Although a typical size of the pages in a virtual address space is also 8 KB, it is not limited to 8 KB.

When a computer program accesses data stored in the physical memory 24 or otherwise performs memory operation, it utilizes virtual memory addresses in the virtual memory 22. The virtual addresses are translated by the memory manager 18 into corresponding real addresses in the real address space of the physical memory 24, thereby enabling the program to access the real memory addresses and perform a specified operation. The memory manager 18 may use a page table to map pages of the virtual memory 22 into pages of the physical memory 24.

A computer program is allowed to access only a specified range of address locations, i.e., a memory block, designated to the computer program, and should not access outside of that memory block. It should be noted that the physical memory addresses corresponding to the memory block in the virtual memory may be a specified range of real addresses locations for storing data by write operations, containing information to be read by read operations, having instructions to be executed by the process, or the like. That is, regardless of the use or contents of the real address locations in the physical memory, the specified memory area is mapped onto an allocated memory block in the virtual address space.

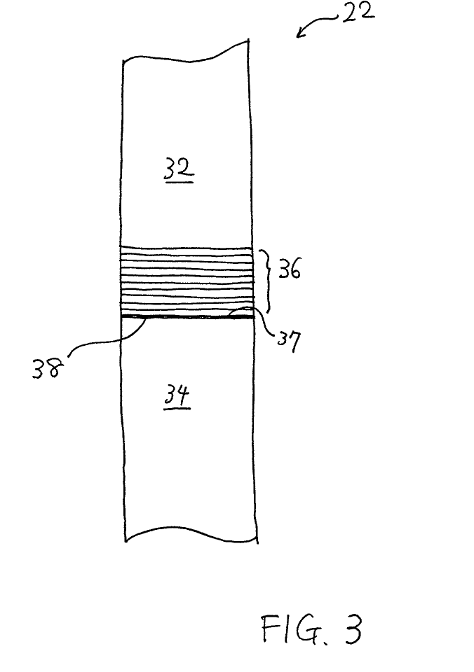

According to a specific embodiment of the present invention, as shown in FIG. 3, the address space of the virtual memory 22 is divided into a plurality of memory regions including a first memory region 32 and a second memory region 34 that adjoins the first memory region 32. The boundary of the two regions 32 and 34 is denoted by a numeral reference 38.

The memory allocator 14 allocates a memory block 36 to be used by a computer program so that a memory block boundary 37 aligns with the region boundary 38 in the virtual memory 22, as shown in FIG. 3. The memory block 36 is entirely within the first memory region 32. The memory block 36 may have the same size as that of the first memory region 32 but not larger than the memory region 32. Thus, any memory operations of the computer program should be within the memory block 36, and should not go beyond the region boundary 38.

In allocating the memory block 36, for example, the memory allocator 14 may first determine the size of the memory block 36, such as a fixed number of address locations to be used by the computer program, and may then determine a starting address in the first memory region 32 so that the memory block 36 ends at the end of the first region 32.

The error detector 16, coupled with said program execution module 12, detects the computer program accessing the second region 32. The error detector 16 may report the detected memory access violation by issuing an error message indicating a memory overrun or over-indexing. The error detector 16 may be implemented as a part of the memory management system or memory manager 18.

According to a specific embodiment of the present invention, the first memory region 32 is a mapped region, and the second memory region 34 is an unmapped region. That is, virtual addresses in the first memory region 32 are associated with real addresses in the physical memory 24, while virtual addresses in the second memory region 34 are not associated with real addresses of the physical memory 24.

In a specific embodiment of the present invention, the second memory region 34 is first mapped along with the first region 32 for the memory block allocation, and then the second region 34 is unmapped before running the test so as to provide a “red zone” to catch a memory overrun or over-indexing of the computer program. If the virtual address space of the virtual memory 22 has not been mapped, the above-mentioned mapped/unmapped region arrangement can be done by only mapping the first region 32 including the memory block 36. In addition, the first memory region 34 (including the memory block 36) may be allocated as an isolated mapped region within a larger unmapped region. For example, if the virtual memory 22 has a sufficiently large unmapped region, the first memory region 32 including the memory block 36 may be defined, by appropriate mapping, as a mapped “island” within the remaining unmapped region which serves as the second memory region 34.

By arranging the mapped and unmapped regions as described above, when the computer program overruns the memory block 36 and attempts to access the second region 34, the attempted access fails because of the invalid addresses of the second region 34. Thus, the unmapped region sometimes referred to as a “red zone.” The memory manager 18 typically signals such an access fault caused by the invalid memory address. The error detector 16 observes the access fault signal and reports the memory access violation.

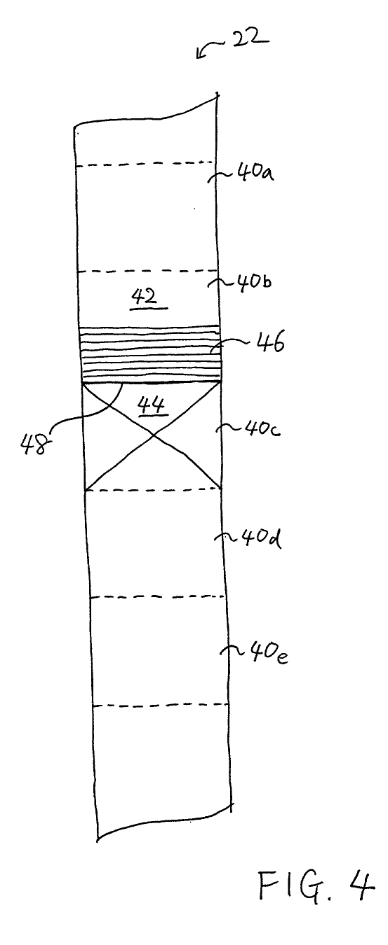

FIG. 4 schematically illustrates a virtual address space of the virtual memory 22 in accordance with a specific embodiment of the present invention, where the virtual address space is divided into a plurality of pages 40 (40a, 40b, 40c . . . ). The boundary between a first memory region 42 and a second memory region 44 is a page boundary 48 of the virtual memory 22. The first memory region 42 is a mapped region, and the second memory region 44 is an unmapped region.

A memory block 46 (i.e., the memory address range to which the computer program is allowed to access) is so allocated that it ends at the end of the first memory region 42, i.e. the end of page 40b. This means that the last byte of the memory block 46 is the last byte of page 40b, and the unmapped second region 44 starts with the next page 40c. As shown in FIG. 4, the second memory region 44 includes at least one page 40c of the virtual memory 22. Since mapping and unmapping of a virtual memory space are typically conducted by the page, it is preferable to define the size of the second memory region 44 by a multiple of the page size. A memory overrun or over-indexing is detected when the computer program accesses the unmapped page 40c beyond the page boundary 48.

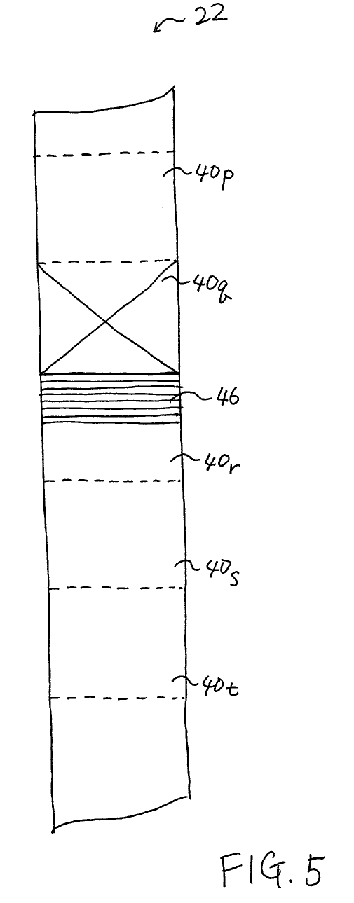

In order to detect a memory underrun or under-indexing, as shown in FIG. 5, the memory block 46 is allocated in the virtual memory 22 so that the memory block 46 starts with the start of page 40r, and the previous page 40q is unmapped. By providing unmapped region before the memory block 46, unauthorized memory access in the opposite direction is also detected.

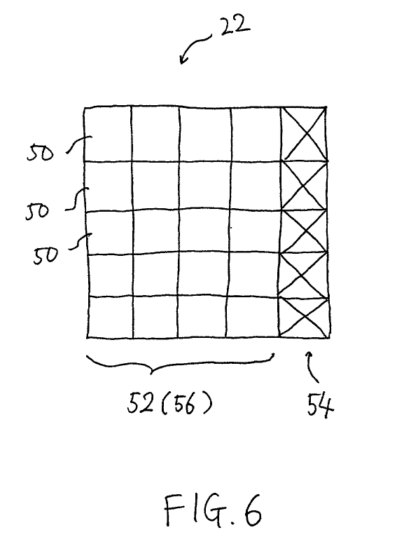

Depending upon the memory use of a computer program to be tested, a designated memory block may be allocated using one or more pages of the virtual memory 22. FIG. 6 illustrates an example of memory block allocation in the virtual memory 22 where virtual pages 50 are arranged in a matrix form having rows and columns. In a matrix arrangement, each page is identified by specifying its row and column in the matrix. As shown in FIG. 6, a memory block 56 has 20 pages (a 5×4 matrix) which is the same as the first region 52. In such a case, an unmapped second region 54 adjoining to the memory block 56 has at least one page, and preferably one column of pages (e.g., 5 pages).

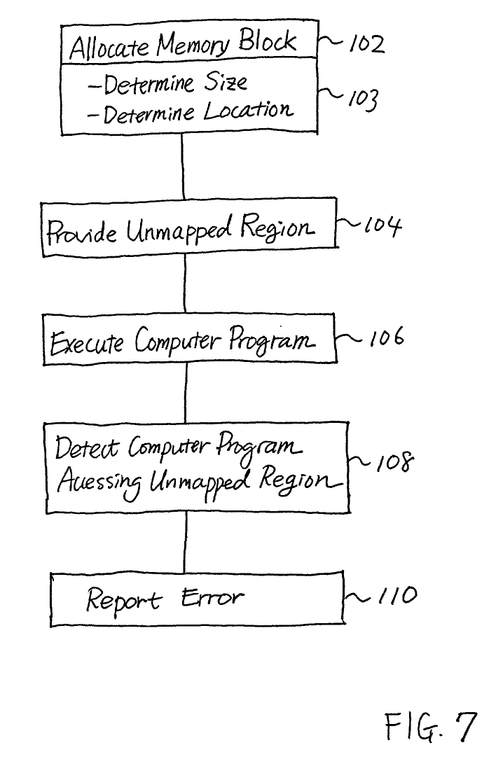

Next, a method for testing memory operations of a computer program is described. FIG. 7 schematically illustrates the method for testing memory operations in accordance with a specific embodiment of the present invention. The method may be performed using the system 10 shown in FIG. 2 with the virtual memory allocation scheme as described above.

First, a memory block 46 to be used by the computer program is allocated in the virtual memory 22 so that a memory block boundary aligns with a region boundary between a first memory region and a second memory region (102). As described above, in a specific embodiment, the region boundary is a page boundary of the virtual memory.

The allocation of a memory block may include determination of the size of the memory block and determination of the address location in the virtual memory 22 (103). For example, in order to allocate a memory block 46 as shown in FIG. 4, the memory allocator 14 may first determine the size of the memory block 46, such as a fixed number of address locations (or the number of bytes) to be used by the computer program. The size of the mapped region (i.e., the first region) is determined to be the smallest block of memory that can contain the data required for the operation being tested. In a specific embodiment, the size of a mapped region is the smallest number of pages that can contain the memory block 46 allocated to the operation of a computer program to be tested.

The memory allocator 14 then determines a starting address in the first memory region 42 (or page 40b) so that the memory block 46 ends at the end of page 40b. In the case where the virtual memory is divided into pages with a fixed size (i.e., a fixed number of address locations per page), the starting address is obtained by subtracting the size of the memory block (for example, 80 bytes) from the page-end address location (for example, the 8192^{nd} byte). The resulting staring address for this example is the 8112^{th} byte.

Next, an unmapped region (sometimes referred to as a “red-zone”) is provided next to the memory block 46 (104). According to a specific embodiment of the present invention, one memory region is first mapped, which is large enough to contain the data (e.g., the memory block 46) required for the computer program to be tested and the red zone for catching over-indexing of the data. Then the address of the start of the data (memory block 46) and the address of the start of the red zone (the second region 44) are computed, as described above, and then the red zone is unmapped. The start addresses are computed so that the mapping and unmapping take place on page boundaries of the virtual memory 22.

Alternatively, providing the red zone may be done at the same time as allocating the memory block 46 at the end of a page (page 40b) adjoining an unmapped page 40c, if the unmapped region (including page 40c) of a sufficient size already exists in the virtual memory 22.

Depending on the size of the memory block 46, the nature of the computer program, and/or required accuracy of the test, two or more pages (40c, 40d etc.) may be unmapped to provide the unmapped second region 44. According to a specific embodiment of the present invention, the unmapped region includes at least one page, and preferably one column of pages when the pages has a matrix form, as shown in FIG. 6. In case of checking an underrun or under-indexing of memory operation, as shown in FIG. 5, at least one previous page (40q) is unmapped for testing the memory block 46.

Although the unmapped region is unusable as a memory space for executing the computer program, the size of the unmapped region (i.e., the second region) should be large enough to catch the most likely indexing error. The most likely errors concern over-indexing or under-indexing along some “stride”. For example, when a list of data is accessed sequentially from the top to the bottom, the stride is one corresponding to the access of one element after another. In this case, the unmapped region need to be at least one element long to catch over-indexing (or under-indexing) by one. When a program is accessing every second element of the list, e.g., every odd-numbered element, the stride is two and the unmapped region need to be at least two elements long. If the algorithm of the program is a binary search, the maximum stride is half the maximum length of the list, and thus the unmapped region should also have at least half the maximum length of the list.

When the data structure is an n-dimensional array, the most likely indexing error has a magnitude equal to the maximum stride along a particular dimension times the amount of memory covered by the stride. For example, given an array of N columns where each column has M contiguous elements of data, an indexing scheme that moves from one column to another strides over M elements. Thus, the unmapped region should be at least M elements long. FIG. 6 shows an example of 2-dimensional array with 4 columns, each column having 5 pages (or 8×5 KB).

Referring back to FIG. 7, the computer program is executed using the virtual memory 22 with the mapped/unmapped memory arrangement (106). A memory overrun/underrun is detected when the computer program accesses the unmapped region in the virtual memory 22 (108). In addition, when such an access fault is detected, an error message indicating a memory overrun/underrun may be issued (110).

The detection of an unauthorized memory operation may be done by observing an access fault caused by the computer program accessing the unmapped region. Computer memory hardware operates only with physical addresses, while computer software operates only with virtual addresses. Thus, whenever a computer program refers to an address to load, store, or perform any other operation, the virtual address that is supplies must be translated into a physical address. This is typically done by the virtual memory subsystem of the computer software (such as the memory management system mentioned above), which is typically a combination of hardware and software. If the virtual memory subsystem is unable to translate the virtual address into a physical address, which would be the case if the virtual address space had been unmapped, the subsystem will indicate a fault.

It should be noted that by providing an unmapped region adjoining the memory block allocated to the computer program, unauthorized memory operations are detected simply executing the computer program without modifying the source code or recompiling the modified source code.

In addition, since any attempted access to an unmapped virtual address causes an access fault regardless of the type of memory operation, out-of-range access for read, write, and execution of the memory contents are all detected using the memory allocation scheme of the present invention.

Furthermore, providing an unmapped region adjoined to the memory block (or unmapping the next page) is superior to, for example, storing an invalid value or instruction (such as the root −1 or division by 0) in memory locations next to the memory block. Although such invalid value/instruction may also cause an error for read or execution operation thereon, an unauthorized write operation replacing the contents of that memory location will not be detected, unless the access itself is monitored by a test subroutine or the like.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for testing memory operations of a computer program using a virtual memory associated with a physical memory, said virtual memory being divided into a plurality of memory regions, each memory region having virtual addresses, said method comprising:
allocating a memory block to be used by the computer program in said virtual memory so that a memory block boundary aligns with a boundary between a first memory region and a second memory region of said virtual memory, said memory block being entirely within said first memory region;
executing said computer program using said virtual memory; and
detecting said computer program accessing said second region of said virtual memory.

2. A method according to claim 1, wherein said first memory region is a mapped region having virtual addresses associated with real addresses in the physical memory, and said second memory region is an unmapped region having virtual addresses not associated with real addresses of the physical memory.

3. A method according to claim 2, wherein said detecting includes observing an access fault caused by said computer program accessing said unmapped region.

4. A method according to claim 1, wherein said allocating includes:
determining a size of said memory block to be used by said computer program; and
determining a starting address in said first memory region so that said memory block ends at the end of said first region.

5. A method according to claim 4, wherein said allocating further includes:
unmapping said second memory region so that virtual addresses therein are dissociated from real addresses in the physical memory.

6. A method according to claim 1, wherein said virtual memory is divided into a plurality of pages, and said boundary between said first memory region and said second memory region is a page boundary of said virtual memory.

7. A method according to claim 6, wherein said second region includes at least one page of said virtual memory.

8. A method according to claim 1, wherein said virtual memory is divided into a plurality of pages, said pages of said virtual memory are arranged in a matrix, and said second region includes at least one column of said pages.

9. An apparatus for testing memory operations of a computer program using a virtual memory associated with a physical memory, said virtual memory being divided into a plurality of memory regions, each memory region having virtual addresses, said apparatus comprising:
means for allocating a memory block to be used by the computer program in said virtual memory so that a memory block boundary aligns with a boundary between a first memory region and a second memory region of said virtual memory, said memory block being entirely within said first memory region;
means for executing said computer program using said virtual memory; and
means for detecting said computer program accessing said second region of said virtual memory.

10. An apparatus according to claim 9, wherein said first memory region is a mapped region having virtual addresses associated with real addresses in the physical memory, and said second region is an unmapped region having virtual addresses not associated with real addresses of the physical memory.

11. An apparatus according to claim 10, wherein said means for detecting includes means for observing an access fault caused by said computer program accessing said unmapped region.

12. An apparatus according to claim 9, wherein said means for allocating includes:
means for determining a size of said memory block to be used by said computer program; and
means for determining a starting address in said first memory region so that said memory block ends at the end of said first region.

13. An apparatus according to claim 12, wherein said means for allocating further includes:
means for unmapping said second memory region so that virtual addresses therein are dissociated from real addresses in the physical memory.

14. An apparatus according to claim 9, wherein said virtual memory is divided into a plurality of pages, and said boundary between said first memory region and said second memory region is a page boundary of said virtual memory.

15. An apparatus according to claim 14, wherein said second region includes at least one page of said virtual memory.

16. An apparatus according to claim 9, wherein said virtual memory is divided into a plurality of pages, said pages of said virtual memory are arranged in a matrix, and said second region includes at least one column of said pages.

17. A system for testing memory operations of a computer program, said system comprising:
an execution module for executing said computer program;
a physical memory coupled with said execution module, said physical memory having real addresses;
a virtual memory associated with said physical memory, said virtual memory being divided into a plurality of memory regions, each memory region having virtual addresses;
a memory allocator associated with said virtual memory and coupled with said execution module, for allocating a memory block to be used by the computer program in said virtual memory so that a memory block boundary aligns with a boundary between a first memory region and a second memory region of said virtual memory, said memory block being entirely within said first memory region; and
an error detector coupled with said program execution module, for detecting said computer program accessing said second region of said virtual memory.

18. A system according to claim 17, wherein said first memory region is a mapped region having virtual addresses associated with real addresses in the physical memory, and said second region is an unmapped region having virtual addresses not associated with real addresses of the physical memory.

19. A system according to claim 18, further comprising a memory manager coupled with said execution module, said memory allocator, and said physical memory, for associating virtual memory addresses in said virtual memory with corresponding real memory addresses in said physical memory,
wherein said error detector includes an access fault detector coupled with said memory manager, for observing an access fault caused by said computer program accessing said unmapped region.

20. A system according to claim 18, wherein said memory allocator includes:
a size determiner for determining a size of said memory block to be used by said computer program; and
a location determiner for determining a starting address in said first memory region so that said memory block ends at the end of said first region.

21. A system according to claim 20, wherein said memory allocator further includes:
an unmapper, coupled with said memory manager, for unmapping said second memory region so that virtual addresses therein are dissociated from real addresses in the physical memory.

22. A system according to claim 17, wherein said virtual memory is divided into a plurality of pages, and said boundary between said first memory region and said second memory region is a page boundary of said virtual memory.

23. A system according to claim 22, wherein said second region includes at least one page of said virtual memory.

24. A system according to claim 17, wherein said virtual memory is divided into a plurality of pages, said pages of said virtual memory are arranged in a matrix, and said second region includes at least one column of said pages.

25. A program storage device readable by a computer, tangibly embodying a program of instructions executable by the computer to perform a method for testing memory operations of a computer program using a virtual memory associated with a physical memory, said virtual memory being divided into a plurality of memory regions, each memory region having virtual addresses, said method comprising:
allocating a memory block to be used by the computer program in said virtual memory so that a memory block boundary aligns with a boundary between a first memory region and a second memory region of said virtual memory, said memory block being entirely within said first memory region;
executing said computer program using said virtual memory; and
detecting said computer program accessing said second region of said virtual memory.

26. A program storage device according to claim 25, wherein said first memory region is a mapped region having virtual addresses associated with real addresses in the physical memory, and said second region is an unmapped region having virtual addresses not associated with real addresses of the physical memory.

27. A program storage device according to claim 26, wherein said detecting includes observing an access fault caused by said computer program accessing said unmapped region.
